(19) United States
(12) Patent Application Publication
(10) Pub. No.: US 2014/0049425 A1
(43) Pub. Date: Feb. 20, 2014

(54) SIGNAL SOURCE DEVICE PROVIDING MULTI-POLARITY SIGNALS

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventor: XIAO-LIAN HE, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/968,366

(22) Filed: Aug. 15, 2013

(30) Foreign Application Priority Data
Aug. 17, 2012 (CN) 2012102938489

(51) Int. Cl. H01Q 21/06

(52) U.S. Cl. CPC H01Q 21/06
USPC 342/361

(57) ABSTRACT

A signal source simultaneously emits horizontally polarized and vertically polarized signals and includes an enclosure, a power source and a signal generator received in the enclosure, and a first antenna and a second antenna set on an outer surface of the enclosure. The second antenna is perpendicular to the first antenna. The signal generator generates a comb-shaped signal having a predetermined frequency and the comb-shaped signal is split to two sub-signals of equal power by the signal generator, and the sub-signals are transmitted into a test environment via the first antenna and the second antenna.

### BACKGROUND

1. Technical Field

The present disclosure relates to signal sources, and particularly to a signal source providing multiple types of signals.

2. Description of Related Art

An electronic device needs to pass an electromagnetic compatibility (EMC) test before it leaves the factory. A testing system executes the EMC test by applying horizontal polarity signals and vertical polarity signals. However, a signal source that executes the EMC test cannot simultaneously emit the horizontal polarity signals and the vertical polarity signals. Therefore, the electronic device needs to be tested twice, which affects efficiency of the EMC test.

Therefore, it is desirable to provide a means which can overcome the above-mentioned problem.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments.

FIG. 1 is an isometric view of a signal source in accordance with an exemplary embodiment of the present disclosure.

FIG. 2 is a block diagram of one embodiment of the signal source of FIG. 1.

### DETAILED DESCRIPTION

Embodiments of the disclosure are described with reference to the drawings.

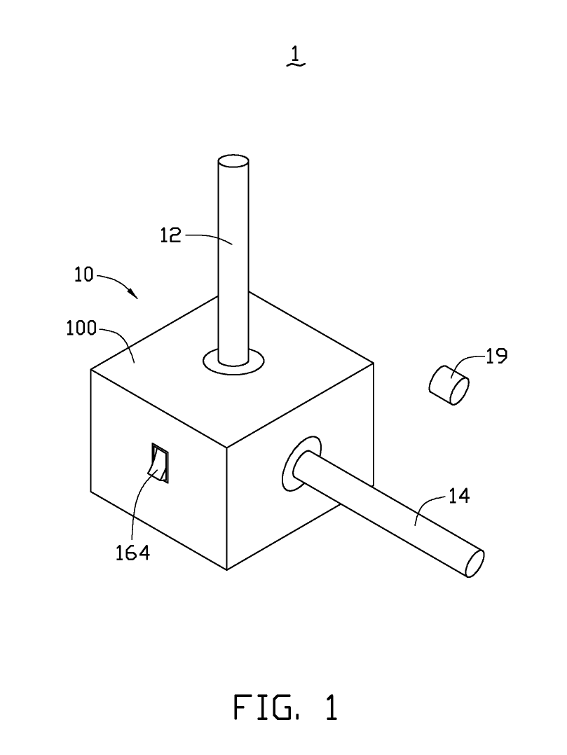

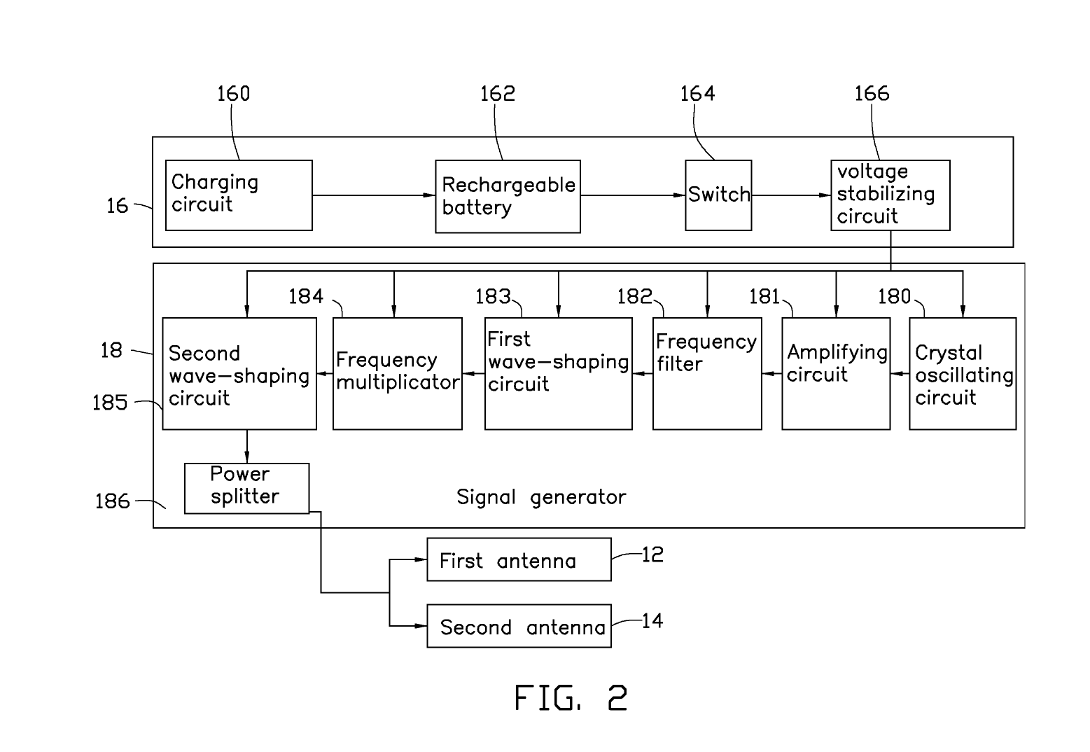

Referring to FIGS. 1 and 2, a signal source 1 includes an enclosure 10, a first antenna 12, a second antenna 14, a power source 16, a signal generator 18, and an impedance matcher 19. The power source 16 and the signal generator 18 are received in the enclosure 10. The first antenna 12 and the second antenna 14 are set on two perpendicular outer surfaces 100 of the enclosure 10. Each of the first antenna 12 and the second antenna 14 is connected to the signal generator 18 in the enclosure 10. The signal generator 18 generates a comb-shaped signal having a predetermined frequency when powered by the power source 16. The comb-shaped signal is distributed into two sub-signals of equal power. The sub-signals are transmitted to the environment via the first antenna 12 and the second antenna 14 perpendicular to the first antenna 12. In this embodiment, the comb-shaped signal is a comb pulse.

The enclosure 10 is made of conductive material and employs a hermetically sealed structure to shield the power source 16 and the signal generator 18 from external interference. The enclosure 10 includes at least two outer surfaces 100 perpendicular to each other. In this embodiment, the enclosure 10 is a hollow rectangular metal chamber.

Each of the first antenna 12 and the second antenna 14 is an elongated rod and made of conductive material. An impedance of the first antenna 12 is equal to an impedance of the second antenna 14. The first antenna 12 and the second antenna 14 are set on the two outer surfaces 100 perpendicular to each other. The first antenna 12 and the second antenna 14 are also perpendicular to the outer surface 100 supporting them. In use, one of the first antenna 12 and the second antenna 14 is extended horizontally, parallel to the floor, the other is extended vertically, in a direction perpendicular to the floor. Thus, the first antenna 12 and the second antenna 14 can transmit both horizontal polarity signals and vertical polarity signals.

The power source 16 includes a charging circuit 160, a rechargeable battery 162, a switch 164, and a voltage stabilizing circuit 166. The charging circuit 160, the rechargeable battery 162, the switch 164, and the voltage stabilizing circuit 166 are connected in order, to form a power loop. The charging circuit 160 is connected to an external power source (not shown) to charge the rechargeable battery 162. The switch 164 includes a mechanical portion that is set on one of the outer surfaces 100 of the enclosure 10 to control the on-off state of the power loop, and then activate or close down the signal source 1. The voltage stabilizing circuit 166 stabilizes a power signal from the rechargeable battery 162 and transforms the power signal into a number of different specified voltages corresponding to different elements in the signal generator 18.

The signal generator 18 includes a crystal oscillating circuit 180, an amplifying circuit 181, a frequency filter 182, a first wave-shaping circuit 183, a frequency multiplicator 184, a second wave-shaping circuit 185, and a power splitter 186. The crystal oscillating circuit 180, the amplifying circuit 181, the frequency filter 182, the first wave-shaping circuit 183, the frequency multiplicator 184, the second wave-shaping circuit 185, and the power splitter 186 are connected in order. The voltage stabilizing circuit 166 provides specified and stabilized voltages to the crystal oscillating circuit 180, the amplifying circuit 181, the frequency filter 182, the first wave-shaping circuit 183, the frequency multiplicator 184, and the second wave-shaping circuit 185.

The crystal oscillating circuit 180 generates an oscillating signal having a predetermined frequency. The amplifying circuit 181 amplifies the oscillating signal generated by the crystal oscillating circuit 180. The frequency filter 182 filters out impulses and noise in the amplified oscillating signal. The first wave-shaping circuit 183 shapes the filtered oscillating signal, and then transmits the oscillating signal to the frequency multiplicator 184. The frequency multiplicator 184 outputs a frequency multiplication of the oscillating signal to form the comb-shaped signal. The second wave-shaping circuit 185 regulates the comb-shaped signal outputted from the frequency multiplicator 184. The power splitter 186 splits the regulated comb-shaped signal into the two sub-signals of equal power and transmits the sub-signals via the first antenna 12 and the second antenna 14.

The impedance matcher 19 is set on the outer surface 100 of the enclosure 10 to replace one of the first antenna 12 and the second antenna 14 when only one antenna is being utilized. An impedance of the impedance matcher 19 is the same as the impedance of the first antenna 12 and the second antenna 14. Thus, the impedance matcher 19 balances the overall impedance of the signal source 1. In this embodiment, the impedance matcher 19 is a circular block.

The signal source 1 integrates two antennas 12, 14 perpendicular to each other to simultaneously transmit horizontal polarity signals and vertical polarity signals. Therefore, test efficiency of the EMC test for the electronic device is improved.

While various exemplary and preferred embodiments have been described, it is to be understood that the present disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A signal source, comprising:
an enclosure comprising at least one outer surface;
a power source received in the enclosure;
a signal generator received in the enclosure and connected to the power source;
a first antenna set on the at least one outer surface and connected to the signal generator; and
a second antenna set on the at least one outer surface, extending along a direction perpendicular to the first antenna, and connected to the signal generator;
wherein the signal generator receives a power provided from the power source and generates a comb-shaped signal having a predetermined frequency, the comb-shaped signal is split into two sub-signals of equal power by the signal generator, and the sub-signals are correspondingly transmitted to the environment via the first antenna and the second antenna.

2. The signal source of claim 1, wherein the enclosure is made of conductive material and employs a hermetically sealed structure.

3. The signal source of claim 2, wherein the enclosure is a hollow rectangular metal chamber.

4. The signal source of claim 1, wherein impedance of the first antenna is equal to impedance of the second antenna.

5. The signal source of claim 4, wherein the signal source further comprises an impedance matcher configured to replace the first antenna or the second antenna, impedance of the impedance matcher is the same as the impedance of the first antenna or the second antenna.

6. The signal source of claim 5, wherein the impedance matcher is a circular block.

7. The signal source of claim 1, wherein the enclosure comprises two outer surfaces perpendicular to each other, the first antenna and the second antenna are correspondingly set on these two outer surfaces, and the first antenna and the second antenna are correspondingly perpendicular to the outer surfaces supporting them.

8. The signal source of claim 1, wherein the power source comprises a charging circuit, a rechargeable battery, a switch, and a voltage stabilizing circuit connected in order, the charging circuit is connected to an external power source to charge the rechargeable battery, the switch is set on one of the outer surfaces of the enclosure to control an on-off of the power source, and the voltage stabilizing circuit stabilizes a power signal from the rechargeable battery and transforms the power signal into a plurality of different specified voltages corresponding to different elements in the signal generator.

9. The signal source of claim 1, wherein the signal generator comprises a crystal oscillating circuit, an amplifying circuit, a frequency filter, a frequency multiplicator, and a power splitter connected in order, the crystal oscillating circuit generates an oscillating signal having a predetermined frequency, the amplifying circuit amplifies the oscillating signal generated from the crystal oscillating circuit, the frequency filter filters out impulses and noise in the amplified oscillating signal, the frequency multiplicator outputs a frequency multiplication of the oscillating signal to form the comb-shaped signal, and the power splitter splits the comb-shaped signal to two sub-signals of equal power and correspondingly transmits the sub-signals via the first antenna and the second antenna.

10. The signal source of claim 8, wherein the signal generator further comprises a first wave-shaping circuit connected between the frequency filter and the frequency multiplicator and a second wave-shaping circuit connected between the frequency multiplicator and the power splitter, the first wave-shaping circuit shapes the oscillating signal filtered out the impulsive noise, and the second wave-shaping circuit regulates the comb-shaped signal outputted from the frequency multiplicator.
